(19) United States
(12) Patent Application Publication
(10) Pub. No.: US 2015/0015182 A1
(43) Pub. Date: Jan. 15, 2015

(54) SYSTEM AND METHOD FOR CHARGING MOBILE DEVICES AT A VENUE

(71) Applicant: Puck Charger Systems Pty Ltd, Sydney, New South Wales (AU)

(72) Inventors: Sean Brandtman, Sydney (AU); Andrew Gemmell, Sydney (AU)

(21) Appl. No.: 14/374,883

(22) PCT Filed: Jan. 31, 2013
(86) PCT No.: PCT/AU2013/000078

§ 371 Date: Jul. 25, 2014

(30) Foreign Application Priority Data
Feb. 7, 2012 (AU) 2012900432
Oct. 22, 2012 (AU) 2012904642

(51) Int. Cl. H02J 7/00

(52) U.S. Cl. CPC H02J 7/0027; H02J 7/0054; H02J 7/0042
USPC 320/103

(57) ABSTRACT

Systems and methods for charging mobile devices are described, embodiments of the systems including: a base station; and a plurality of satellite charging units; each of the satellite charging units include a rechargeable power supply which can be recharged by the base station; each of the satellite units are arranged to recharge mobile devices by way of transferring charge from their power supply to the mobile device.

### TECHNICAL FIELD

The present invention relates to systems and methods for charging mobile devices and particularly to providing a facility for charging mobile devices at venues.

### BACKGROUND TO THE INVENTION

Today's latest generation mobile smart phones offer users more features, capabilities and power than ever before. Whether it's surfing the web, accessing email, running applications or making voice and video calls, smart phones have become a ubiquitous, indispensible technology for business and personal use. However, as smart phones have increased in their capabilities, so too has their demand on power. As a result many smart phones need to be recharged once or more times each day.

Mobile devices, such as smart phones, are typically sold along with a mains powered charger. Users are therefore constrained to charging their device where they have access to mains power.

There exist emergency phone power supplies which are powered by removable batteries. However, these are of no use unless the user carries a portable charger and spare batteries with them at all time, which is not convenient. There remains a need for improved charging solutions for mobile devices.

### SUMMARY OF THE INVENTION

In a first aspect the present invention provides a system for charging mobile devices including: a base station; and a plurality of satellite charging units; each of the satellite charging units include a rechargeable power supply which can be recharged by the base station; each of the satellite units are arranged to recharge mobile devices by way of transferring charge from their power supply to the mobile device.

The base station may be arranged to store the satellite units and charges the satellite units whilst they are stored.

The satellite units may include electrical connections to enable charging by the base station.

The electrical connections may be substantially circular and surround the puck to thereby allow the puck to be inserted into the base station in various angular orientations.

The base station and the puck may include pairs of electrical connections which can be connected to one another either way around.

The satellite charging units may electronic display screen for displaying images or videos.

The satellite units may be arranged to be paged by the base station.

Each satellite unit may be arranged to simultaneously charge more than one mobile device.

The system may prompt a user to install a software application on their mobile device.

In a second aspect the present invention provides a method of providing a facility for charging mobile devices at a public venue including the steps of: providing a system according to the first aspect of the invention at the venue.

The method may further include the step of charging patrons for use of the satellite units.

The method may include the step of providing the system to the operator of the venue free of charge and placing advertising messages on the satellite units.

The method may further include the step of installing a software application on mobile devices of users.

The software application may be configured to alert the user that the charge level of their mobile device is low.

The software application may be configured to allow the user to locate a nearby system for charging their mobile device.

The software program may be configured to broadcast a message to other parties to notify them that the charge level of the user's mobile device is low.

### BRIEF DESCRIPTION OF THE DRAWINGS

An embodiment of the present invention will now be described, by way of example only, with reference to the accompanying drawings, in which:

FIG. 1 is a schematic view of a system according to an embodiment of the invention;

FIG. 2 is a perspective view of a base station used in the system of FIG. 1;

FIG. 3 is a top view of the base station of FIG. 2;

FIG. 4 is a perspective view of a satellite charging unit used in the system of FIG. 1;

FIG. 5 is a schematic view of the base station of FIG. 2; and

FIG. 6 is a schematic view of a satellite charging unit of FIG. 4.

### DETAILED DESCRIPTION OF THE PREFERRED EMBODIMENT

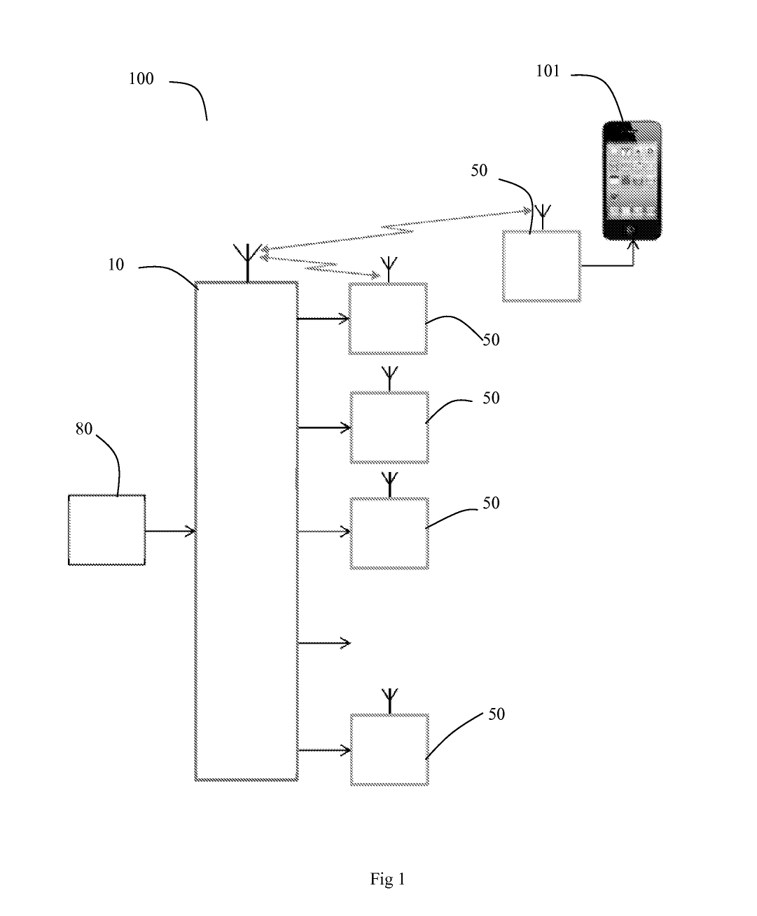

Referring to FIG. 1, a system 100 for charging mobile devices is shown and includes a base station 10 and five satellite charging units hereinafter referred to as “pucks” 50.

Base station 10 includes five bays, each of which can receive and store a puck 50. Each bay is provided with electrical connections used to connect to and charge the puck 50 whilst it is present in a bay. Base station 10 communicates wirelessly with each puck 50 and monitors and displays each puck's charge status. Base station 10 is powered from a mains DC plug pack 80.

Each puck 50 includes a rechargeable power supply in the form of a rechargeable LiPo battery. A puck 50 is charged by placing it in a bay on the base station 10 so that external electrical connections on each of the bay and the puck come into contact with one another. Pucks 50 communicate their charge status to the base station 10 using digital radio. The pucks 50 can be removed from the base station 10 and be connected to a mobile device, such as a mobile phone 101 to transfer charge from the on board LiPo battery to the mobile phone and hence charge the phone.

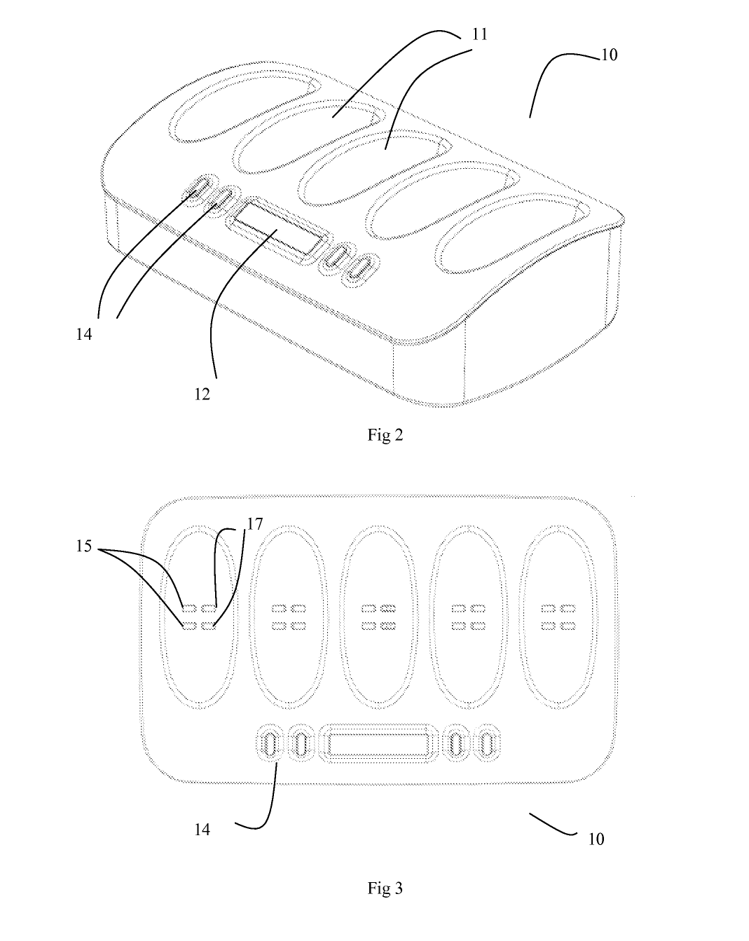

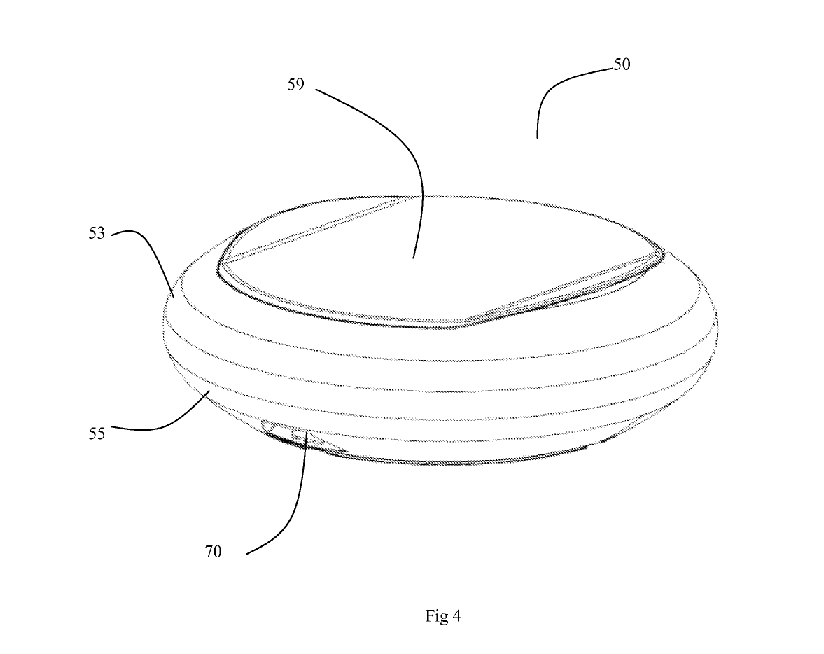

Referring to FIGS. 2 and 3, base station 10 includes bays 11. Each bay includes a pair of electrical contacts 15, 17 which constitute positive and negative DC terminals.

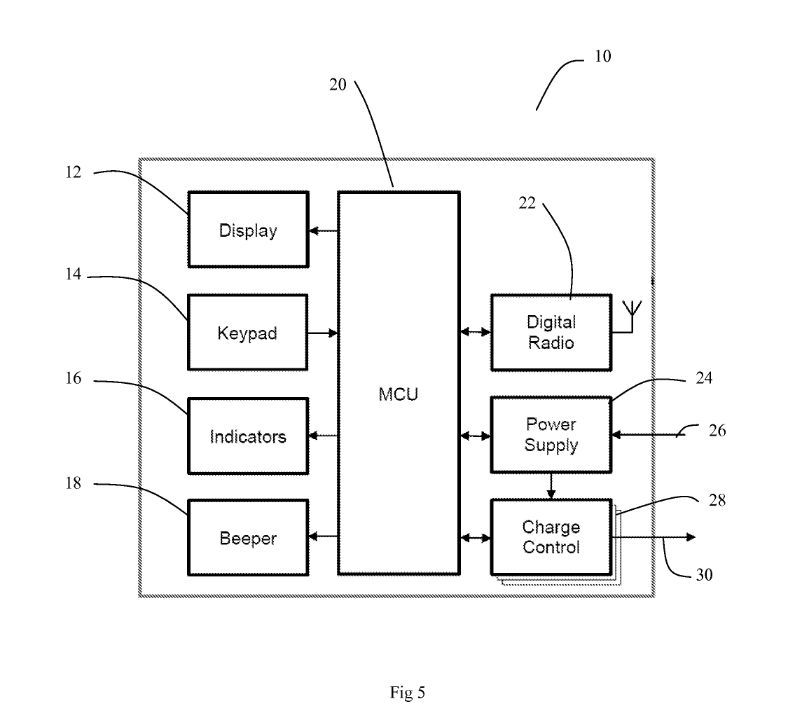

Referring to FIG. 4, puck 50 includes electrical connections in the form of two metal rings 53, 55 which encircle the puck. When a puck 50 is inserted into a bay 11, electrical contacts 15 come into contact with one of rings 53, and the other electrical contact 17 comes into contact with the other of rings 55. Because the electrical contacts 53, 55 encircle the outer surface of the puck, this allows the puck to be inserted into the bay in any angular orientation about the central axis of the ring shaped conductors.

The puck has within it a “low impedance rectifier”. It is an active circuit which accepts a voltage of either polarity and produces an output voltage of a fixed polarity (to power the puck) with very little forward voltage drop and power loss. The main basis of the circuit is a polarity sensing circuit and a series of 4 high current, low impedance FETS organised in a H bridge. The sensing circuit detects the applied polarity and switches on complementary pairs of FETS in such a way as to produce a rectified output voltage. The FETS when switched on have very little resistance so the voltage drop and corresponding power loss is small and the heating low. Because the puck can accept voltage of either polarity, this means that the puck can be inserted either way round into the bay, with ring 53 aligning with contacts 15, and ring 55 aligning with contacts 17, or vice-versa.

Referring to FIG. 5, the functional blocks of base station 10 are shown in detail. The operations of base station 10 are controlled by a microcontroller unit (“MCU”) 20 which is a re-programmable single chip microcontroller with integrated RAM and Flash. Display 12 is a night readable OLED display and is used to display charge state/status for each puck 50 (i.e. % of full charge, charging, charged, discharging, idle etc).

Keypad 14 consists of a next and page button. Pressing the next button cycles through each puck 50 displaying its charge state/status on the OLED. Pucks 50 may be paged using the base station. Momentarily pressing the page button causes the selected puck to flash once. Holding the page button causes the selected puck to begin flashing to assist in locating the Puck.

Indicators 16 include a green power LED. Each bay also has a dedicated tricolour LED (i.e. red/orange/green) which is used to show the charge status of a puck 50 when in the bay (red=no puck present, orange=charging, green=fully charged).

Beeper 18 is an on board piezo transducer for generating beeps. Beeps may be used to provide feedback on key presses or when a puck has completed charging.

Digital radio 22 is a 900 MHz FM transceiver used to establish bi-directional wireless communications with the pucks 50.

Power supply 24 accepts power from the connected external DC power plug 80 and produces voltage rails for on board circuitry. The power supply also includes a main ON/OFF power switch and appropriate fuse protection.

Charge control circuits 30 enable/disable and monitor the provision of charge to each puck 50 by way of electrical connections 30. These circuits provide short circuit protection.

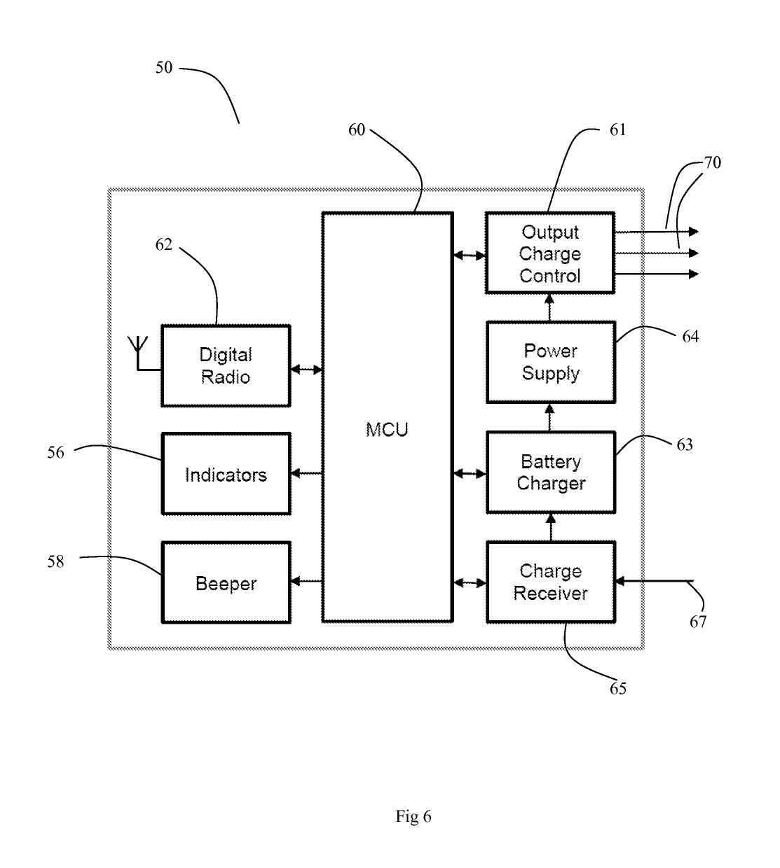

Referring to FIG. 6, the functional blocks of a puck 50 are shown in detail. MCU 60 is a low power, in circuit re-programmable, single chip microcontroller with integrated RAM and Flash. Indicators 56 include a series of white LEDs which flash during paging or upon removal of a puck 50 from a bay of the base station 10.

Beeper 58 is an on-board piezo transducer which can be used to generate tones to assist with locating the puck 50 during paging.

Charge receiver 65 is a circuit used to receive and rectify power from the base station 10 received by way of electrical connection 67.

Battery charger 63 is a circuit used to manage charging of the on board LiPo battery (not shown) charging. It also maintains a measure of battery charge levels.

Power supply 64 is a circuit which conditions power from the internal LiPo battery and produces voltage rails for on board circuitry and charging of connected phones.

Output charge control 61 is a circuit which enables/disables power to charge an externally connected phone. Multiple outputs 70 are provided to allow simultaneous charging of a number of phones. These outputs may be fitted with various types of connectors to allow connection to a variety of styles of mobile devices or to connect to multiple devices. Power to outputs 70 phone is disabled during charging of the puck 50 or when the puck battery is depleted.

Digital radio 62 is a 900 MHz FM transceiver used to establish bi-directional wireless communications with base station 10.

System 100 is intended for use in venues such as bars, restaurants, cafes, airports, on aircraft etc. A patron at such a venue may find that the battery of their mobile phone 101 is getting low. They may be waiting for friends to contact them or otherwise require continued use of their phone to check emails, websites etc. They can therefore make a request to the operator of the venue to use one of pucks 50 for a period of time. The operator hands the patron a puck 50. The patron may then return to their seat or any other location at the venue and connect their phone to the puck 50 to commence charging of their phone. Their phone therefore remains operational to enable them to be contacted, contact others, or perform any other task with their phone. Furthermore, after a period of time their phone will have an increased level of charge, enabling them to return the puck 50 to the operator and continue use of their phone.

The operator of a venue may purchase a system 100 and then recoup their investment by charging patrons for use of pucks 50. In an alternative business model, the pucks may be provided with spaces 59 for applying advertising messages or other branding. Advertisers or sponsors pay for displaying their advertising or branding on the pucks 50. In this model, operators of venues may be offered systems free of charge, and may opt not to charge patrons, but offer use of pucks as a free service. The advertising space may be provided in the form of a video screen, which allows display of video advertising messages. Furthermore, this allows the messages to be changed centrally at the base station which updates the pucks with new advertising messages.

When a user connects their phone to a puck 50, MCU may communicate with the phone to prompt the user to install a software application on their phone. The software application is made available by a wireless internet connection with an application store. The software application has various features as follows:

Geographic location of puck charging venues—users can access a map screen whereby they can see locations of venues nearby which offer the use of puck type chargers.

Low charge notification—when the user's phone charge drops below a pre-defined threshold, the application notifies the user. It may also notify the user of nearby participating charging venues based on GPS information provided by the user's mobile device.

Social Networking—the software links to social networking systems in which the user participates. At low charge the software may post a message via the user's social media systems to inform their contacts that their phone is at low charge to warn them that the user may soon become uncontactable. When the user locates a charging venue and connects their phone to a puck the application sends a subsequent message informing the users contacts of their whereabouts and informing them that the user is charging their phone. Users may be able to determine who of their contacts is currently using a puck charger, and at what location.

Rewards—a user may be offered rewards if they opt to use a puck charger at a particular location such as complimentary food or drink.

The software application may include a user survey function whereby a user can provide feedback on aspects of the venue such as service levels and provide other comments relating to their experience at the venue.

In some embodiments a WiFi capability can be implemented in either the puck 50 or the base station 10. Users may then access the internet using the provided WiFi connection whilst they are in the vicinity of the system.

In some embodiments, the base station may take the form of a vending machine. Puck chargers are stored and charged within the vending machine. A user makes a payment at the vending machine and a puck charger is dispensed for them to use. The vending machine includes a return chute for receiving returned pucks, which are recharged for subsequent vending operations.

In the embodiment described above, the patron at a venue requested use of a puck from staff. In other embodiments, the operator of a venue may distribute pucks at locations around the venue, such as by securing them to tables or the like. Patrons may then utilise the puck chargers at will. The operator then substitutes the pucks for re-charged pucks as and when they become discharged over time as a result of use by patrons. The base station can identify the charge level of pucks to notify the operator of pucks that require substitution.

In the embodiment described above, pucks charged a users phone by way of a physical electrical connection. In other embodiments pucks 50 may be configured to employ a contactless charging system such as a charging pad.

In the scenario described above, the patron wished to charge up their mobile phone, similarly, the system could be used to charge other types of mobile electronic devices such as tablet PCs, webpads, or other computing devices.

It can be seen that embodiments of the invention have at least one of the following advantages:

users of mobile devices are able to continue to use their devices and remain contactable or able to contact friends, colleagues or business contacts whilst away from a mains power supply.

users need not transport their own charging devices.

operators of venues are able to retain patrons on their premises who might otherwise leave due to the fact that they need to recharge their phone or other mobile device, thereby prolonging the time their patrons stay and therefore the amount of money they spend at the venue.

operators can attract patrons who might like to know that they can charge their phones at their venue, thus preferring a venue offering pucks 50 over one that does not.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A system for charging mobile devices including:
a base station; and
a plurality of satellite charging units;
each of the satellite charging units include a rechargeable power supply which can be recharged by the base station;
each of the satellite units are arranged to recharge mobile devices by way of transferring charge from their power supply to the mobile device.

2. A system according to claim 1 wherein the base station is arranged to store the satellite units and charges the satellite units whilst they are stored.

3. A system according to claim 1 wherein the satellite units include electrical connections to enable charging by the base station.

4. A system according to claim 3 wherein the electrical connections are substantially circular and surround each satellite unit to thereby allow the satellite unit to be inserted into the base station in various angular orientations.

5. A system according to claim 3 wherein the base station and each satellite unit includes pairs of electrical connections which can be connected to one another either way around.

6. A system according to claim 1 wherein the satellite units are arranged to be paged by the base station.

7. A system according to claim 1 wherein each satellite unit is arranged to simultaneously charge more than one mobile device.

8. A system according to claim 1 wherein the system prompts a user to install a software application on their mobile device.

9. A system according to claim 1 wherein the satellite charging units include electronic display screen for displaying images or videos.

10. A method of providing a facility for charging mobile devices at a venue including the steps of:
providing a system according to claim 1 at the venue.

11. A method according to claim 10 further including the step of charging patrons for use of the satellite units.

12. A method according to claim 10 wherein the system is provided to the operator of the venue free of charge and advertising messages are placed on the satellite units.

13. A method according to claim 10 further including the step of installing a software application on mobile devices of users.

14. A method according to claim 13 wherein the software application is configured to alert the user that the charge level of their mobile device is low.

15. A method according to claim 13 wherein the software application is configured to allow the user to locate a nearby system for charging their mobile device.

16. A method according to claim 13 wherein the software application is configured to broadcast a message to other parties to notify them that the charge level of the user's mobile device is low.

17. A method according to claim 13 wherein the software application is configured to collect customer survey data from the user.
